(19) United States
(12) Patent Application Publication
(10) Pub. No.: US 2009/0082068 A1
(43) Pub. Date: Mar. 26, 2009

(54) COMMUNICATION TERMINAL

(75) Inventor: Norimitsu Sakai, Shizuoka (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Osaka (JP)

(21) Appl. No.: 11/911,058

(22) PCT Filed: Apr. 11, 2006
(86) PCT No.: PCT/JP2006/307656

§ 371 Date: Oct. 9, 2007

(30) Foreign Application Priority Data
Apr. 11, 2005 (JP) 2005-113338

(51) Int. Cl. H04B 1/38

(52) U.S. Cl. 455/567

(57) ABSTRACT

A communication terminal capable of protecting a hard disk drive if a vibration section activates and capable of decreasing the processing wait time of the hard disk drive and the processing wait time of notifying the user is provided. A communication terminal 100 has a communication section 33 for transmitting and receiving various pieces of data to and from an external apparatus, a hard disk drive 35 being provided in a cabinet 15 and capable of reading and writing information, a control section 37 for controlling the communication section 33 and the hard disk drive 35, and a notification unit for notifying the user of an incoming call by the control section 37 based on an incoming call request obtained by the communication section 33, wherein the notification unit has a vibration section 31 for vibrating the cabinet 15. When the control section 37 detects an incoming call request for the communication section 33 during read/write from/to the hard disk drive 35, a protection mode for terminating the read/write from/to the hard disk drive 35 before activating the vibration section 31 can be selected.

### TECHNICAL FIELD

This invention relates to a communication terminal including a vibration section and a hard disk drive in the same cabinet and in particular to an improvement art for decreasing the processing wait time of the hard disk drive and the processing wait time of notifying the user while protecting the hard disk drive from activation of the vibration section.

### BACKGROUND ART

A mobile telephone of a communication terminal in a related art is made up of an operation section, a display section, a communication section, a control section, a storage section, a microphone, a receiver (to hear voice of the communicating party), a loudspeaker of an incoming call notification unit (for outputting a ringing tone or voice), and a vibration section (vibrator) of an incoming call notification unit in a cabinet.

In recent years, a larger storage capacity has been demanded for this kind of communication terminal and a mobile telephone adopting an economically advantageous hard disk drive (HDD) has been proposed.

However, in a mobile telephone including a hard disk drive and a vibration section in the same cabinet, when the vibration section is activated during the read/write time period of the hard disk drive is started, a seek error accompanying head displacement occurs due to the vibration and a read error, a write error, damage to a disk, etc., easily occurs; this is a problem.

Thus, for example, a miniature electronic machine such as an information terminal incorporating a hard disk drive is provided with a sensor for detecting vibration of a cabinet and includes a means for executing at least either of operation suspending processing and stop processing of starting when the sensor detects an anomaly.

In this electronic machine, memory suspend processing involving drive stop is executed as a CPU performs BIOS processing according to SMI (System Management Interrupt) notification accompanying a detection signal output from the vibration sensor. That is, the vibration sensor detects vibration of a vibration section and if the vibration exceeds the allowable range, read/write is suspended and protection processing of the hard disk drive is performed. Accordingly, fault of the hard disk drive is avoided and data destruction caused by the fault is avoided (for example, refer to patent document 1).

Patent document 1: JP-A-2001-184772

### DISCLOSURE OF THE INVENTION

### Problems to be Solved by the Invention

However, in the communication terminal in the related art, since it requires a predetermined time until the sensor detects vibration of the vibration section and until read/write is suspended after the detection, a time lag occurs until read/write is suspended after the vibration is detected, and there is a possibility that the protection processing may be insufficient (late for protection of the hard disk drive, etc.,).

When an incoming call request is received, if the vibration section is stopped until read/write processing of the hard disk drive is “complete,” the time of notifying the user of the incoming call is delayed.

In contrast, if read/write processing is stopped and incoming call notification is first provided and the read/write processing is restarted after the user acknowledges the incoming call, the read/write processing is delayed.

This means that there is a problem of an increase in either the processing wait time of the hard disk drive or the processing wait time of notifying the user.

On the other hand, to reliably protect the hard disk drive, a method of “temporarily” suspending read/write from/to the hard disk drive before a control section receiving an incoming call request starts the vibration section is also possible; however, if read/write from/to the hard disk drive is suspended unconditionally, there is a possibility that important (critical) processing may be suspended and it is feared that a system error will occur.

The invention is embodied for solving the problems in the related art and it is an object of the invention to provide a communication terminal capable of protecting a hard disk drive if a vibration section activates and capable of decreasing the processing wait time of the hard disk drive and the processing wait time of notifying the user.

### Means for Solving the Problems

A communication terminal of the invention is a communication terminal including a communication section for transmitting and receiving various pieces of data to and from an external apparatus, a hard disk drive being provided in a cabinet and capable of reading and writing information, a control section for controlling the communication section and the hard disk drive, and a notification unit for notifying the user of an incoming call by the control section based on an incoming call request obtained by the communication section, wherein the notification unit has a vibration section for vibrating the cabinet, and the communication terminal has a configuration wherein when the control section detects an incoming call request for the communication section during read/write from/to the hard disk drive, a protection mode for terminating the read/write from/to the hard disk drive before activating the vibration section can be selected.

According to the configuration, when an incoming call request is detected during read/write, the control section sets the occupation time period allocated to the operation of the hard disk drive (read/write time period) and the occupation time period allocated to the operation of the vibration section (vibration time period). Accordingly, it is made possible to activate the vibration section in the necessary shortest wait time after causing the hard disk drive to complete the necessary minimum write.

The communication terminal of the invention has the configuration wherein before the vibration section activates, the head of the hard disk drive is retreated from the record face and is maintained at the retreat position until the vibration section stops.

According to the configuration, the head and the record/playback face of the magnetic disk are placed apart from each other so as to prevent a read/write failure caused as the head and the record/playback face come in contact with each other or breakage of the head and the record/playback face because of vibration as the vibration section is activated.

The communication terminal of the invention has the configuration wherein the control section repeats the vibration time period of the vibration section and the read/write time period of the hard disk drive alternately.

According to the configuration, when an incoming call request is detected during read/write, the control section sets a predetermined time share period and distributes the time share period to the vibration time period and the read/write time period alternately.

Therefore, vibration and read/write are executed alternately at a predetermined duty ratio and the still time of the vibration section is allocated to the read/write time and control not increasing both wait times is made possible.

Accordingly, it is made possible to activate the vibration section roughly at the same time as an incoming call request and while the hard disk drive is protected, read/write is executed for decreasing the processing wait time of the hard disk drive, the vibration section is activated in the necessary shortest wait time, the processing wait time of notifying the user is decreased, and incoming call notification is not delayed.

Further, the communication terminal of the invention has the configuration wherein the control section can set any desired duty ratio between the vibration time period and the read/write time period.

According to the configuration, it is made possible to set the optimum time lengths of the vibration time period and the read/write time period of the duty ratio and it is made possible to set the optimum notification vibration pattern for the user or the optimum read/write operation pattern for target data. Accordingly, the ratio between the vibration time period and the read/write time period can be adjusted in response to read/write processing of the hard disk drive, it is made possible to accomplish the effective and efficient vibration notification operation and read/write operation, and a request for critical read/write processing can be satisfied.

The communication terminal of the invention has the configuration wherein when repeating n pairs of the vibration time period and the read/write time period in a given order, the control section inverts the order of the vibration time period and the read/write time period in an arbitrary pair a.

According to the configuration, one of the vibration time period and the read/write time period continues across the pairs a−1 and a and the other continues across the pairs a and a+1. It is made possible to use the time not substantially consumed for the vibration or read/write operation as the read/write time period because of the continuation and accordingly the read/write time period is shortened and effective notification is made possible.

### ADVANTAGES OF THE INVENTION

The invention provides the communication terminal including the communication section, the hard disk drive, the control section for controlling them, and the notification unit for notifying the user of an incoming call obtained by the communication section, wherein the notification unit has a vibration section. The protection mode wherein when an incoming call request is detected during read/write from/to the hard disk drive, the read/write from/to the hard disk drive is terminated before the vibration section is activated is provided in a selectable manner. Therefore, when an incoming call request is detected during read/write, the control section sets the read/write time period and the vibration time period and causes the hard disk drive to complete necessary minimum write and then activates the vibration section. Accordingly, there can be provided the communication terminal having the advantages that the vibration time period and the read/write time period do not overlap, that the hard disk drive can be protected with high accuracy from vibration produced by the vibration section, and that the processing wait time of the hard disk drive and the processing wait time of notifying the user can be decreased.

### BRIEF DESCRIPTION OF THE DRAWINGS

FIG. 1 is an external perspective view of a communication terminal according to a first embodiment of the invention.

FIG. 2 is a block diagram to show the main configuration of the communication terminal shown in FIG. 1.

FIG. 3 is a flowchart of the first embodiment for performing vibration control after completion of minimum necessary HDD write processing.

FIG. 4 is a timing chart of the first embodiment for performing vibration control after completion of minimum necessary HDD write processing.

FIG. 5 is a flowchart of a second embodiment for time-sharing HDD processing and vibration control.

FIG. 6 is a time chart of the second embodiment for time-sharing HDD processing and vibration control.

FIG. 7 is a timing chart of the third embodiment for time-sharing HDD processing and vibration control so that the time period can be changed.

FIG. 8 is a timing chart of a modified example of the third embodiment for time-sharing HDD processing and vibration control so that the duty ratio can be changed.

FIG. 9 is a timing chart of a fourth embodiment for making it possible to change the time period in any desired pair of HDD processing and vibration control.

### DESCRIPTION OF REFERENCE NUMERALS

15 Cabinet
21 Loudspeaker (notification unit)
31 Vibrator section (vibration section; notification unit)
33 Communication section
35 Hard disk drive
37 Control section
100 Mobile telephone (communication terminal)
X HDD operation time (read/write time period)
Y Vibration control time (vibration time period)

### BEST MODE FOR CARRYING OUT THE INVENTION

Communication terminals of embodiments of the invention will be discussed with the accompanying drawings.

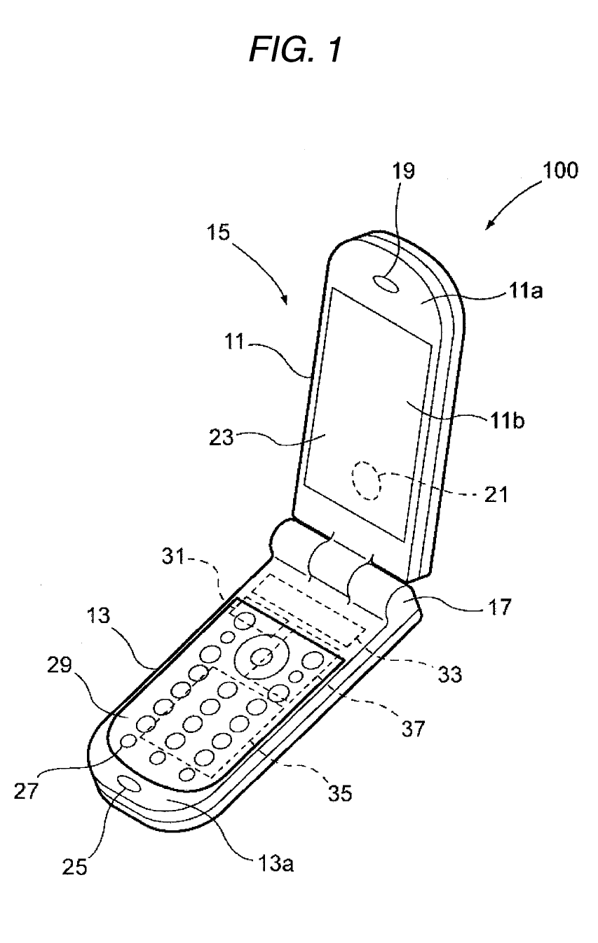

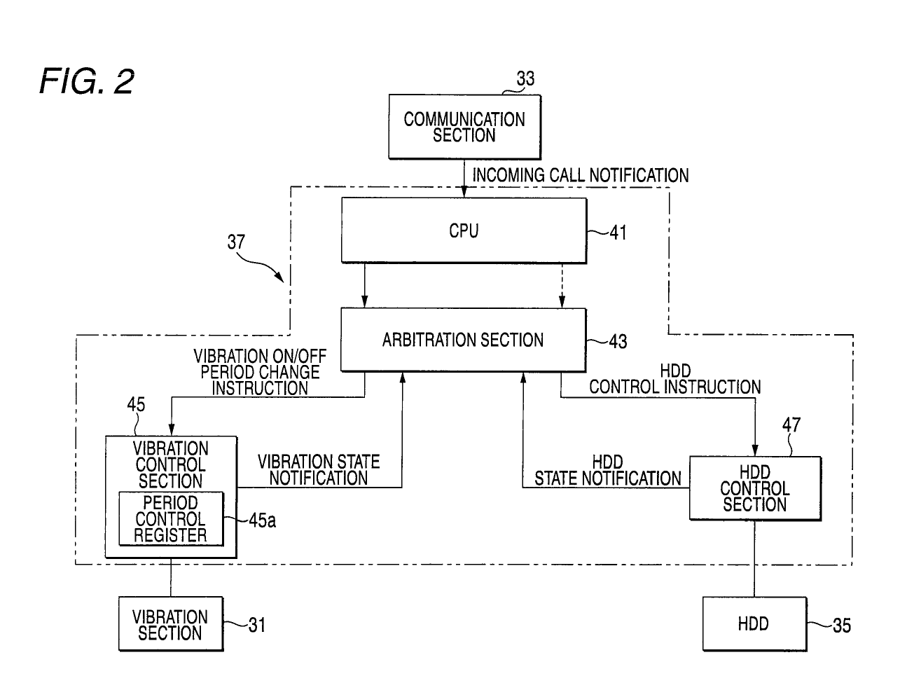

FIG. 1 is an external perspective view of a communication terminal according to a first embodiment of the invention and FIG. 2 is a block diagram to show the main configuration of the communication terminal shown in FIG. 1.

As shown in FIG. 1, a mobile telephone 100 of communication terminal includes a cabinet 15 made up of an upper cabinet 11 and a lower cabinet 13 and a joint device 17 for fixing the upper and lower cabinets 11 and 13 and capable of being folded between the upper and lower cabinets 11 and 13.

The upper cabinet 11 accommodates a reception section (receiver) 19 of a first sound output section, a loudspeaker 21 of a second sound output section serving as a notification unit, a display section 23, a first printed board not shown, etc.

An LCD, etc., implementing the display section 23 is provided on the first printed board.

On the other hand, the lower cabinet 13 accommodates a transmission section (microphone) 25, an operation section 29 made up of a plurality of buttons 27, a vibration section (vibrator section) 31 of a notification unit, a communication section 33, a hard disk drive 35, a control section 37, a detachable battery not shown, a second printed board not shown, etc.

The communication section 33, the hard disk drive 35, the control section 37, a data conversion section, a sound processing section, an image processing section, and the like are installed on the second printed board.

The joint device 17 fixes the upper and lower cabinets 11 and 13 foldably. As the upper cabinet 11 and the lower cabinet 13 are jointed by the joint device 17, when the mobile telephone 100 is unused, it is folded in a state in which the cabinet 15 is closed, namely, in a state in which the upper cabinet 11 faces the lower cabinet 13. On the other hand, when the mobile telephone 100 is used, the cabinet 15 is opened so that the face of the user is opposed to the upper cabinet 11 and the lower cabinet 13.

The receiver 19 is provided on a main face 11a of the upper cabinet 11 facing the lower cabinet 13 when the cabinet 15 is closed, and is disposed so that sound is output from the main face 11a. To usually use the mobile telephone 100 according to the first embodiment, voice of the communicating party is output.

On the other hand, the loudspeaker 21 is provided on a back face 11b on the opposite side to the main face 11a of the upper cabinet 11, and is disposed so that a ringing tone is output from the back face 11b in a mail or telephone call wait state, etc.

The microphone 25 and the operation section 29 are provided on a main face 13a of the lower cabinet 13 opposed to the main face 11a of the upper cabinet 11 in a state in which the cabinet 15 is closed. The vibrator section 31 is vibrated at the incoming call time, thereby notifying the user of an incoming call by vibration.

The communication section 33 transmits and receives various pieces of data to and from a wireless base station of an external apparatus. The hard disk drive 35 is provided in the lower cabinet 13, for example, and causes a playback head to seek to a record/playback area of a magnetic disk for enabling information read/write.

The control section 37 controls the communication section 33 and the hard disk drive 35.

As shown in FIG. 2, the control section 37 is made up of a central processing unit (CPU) 41, an arbitration section 43, a vibration control section 45, and an HDD control section 47. The vibration control section 45 and the HDD control section 47 are connected to the arbitration section 43. The vibration control section 45 is connected to the vibrator section (vibration section) 31 and the HDD control section 47 is connected to the hard disk drive 35.

The control section 37 sends a start signal through the arbitration section 43 to the vibration control section 45 based on an incoming call request obtained by the communication section 33 and activates the vibrator section 31. The control section 37 also sends various pieces of data obtained from the communication section 33 to the HDD control section 47 through the arbitration section 43 and controls read/write processing from/to the hard disk drive 35.

The arbitration section 43 enables arbitration control between the processing for the vibrator section 31 and the processing for the hard disk drive 35 as described later in detail.

That is, the vibration control section 45 is provided with a period control register 45a. The arbitration section 43 references a vibration state notification signal sent from the vibration control section 45 and sends a vibration ON/OFF period change instruction to the vibration control section 45. The arbitration section 43 also references an HDD state notification signal sent from the HDD control section 47 and sends an HDD control instruction to the HDD control section 47.

In the first embodiment, when the control section 37 detects an incoming call request for the communication section 33 during read/write from/to the hard disk drive 35, a protection mode for terminating the read/write from/to the hard disk drive 35 before activating the vibrator section 31 can be selected.

In this case, the read/write from/to the hard disk drive 35 is not performed until “completion” and is stopped when necessary minimum read/write processing terminates, as described later in detail.

The control section 37 sends a control section of the hard disk drive 35 through the arbitration section 43 to the HDD control section 47 so as to retreat the head of the hard disk drive 35 from the record face before the vibrator section 31 activates and maintain the head at the retreat position until the vibrator section 31 is stopped. According to the configuration, the head and the record/playback face of the magnetic disk are placed apart from each other so as to prevent a read/write failure caused as the head and the record/playback face come in contact with each other or breakage of the head and the record/playback face because of vibration as the vibrator section 31 is activated.

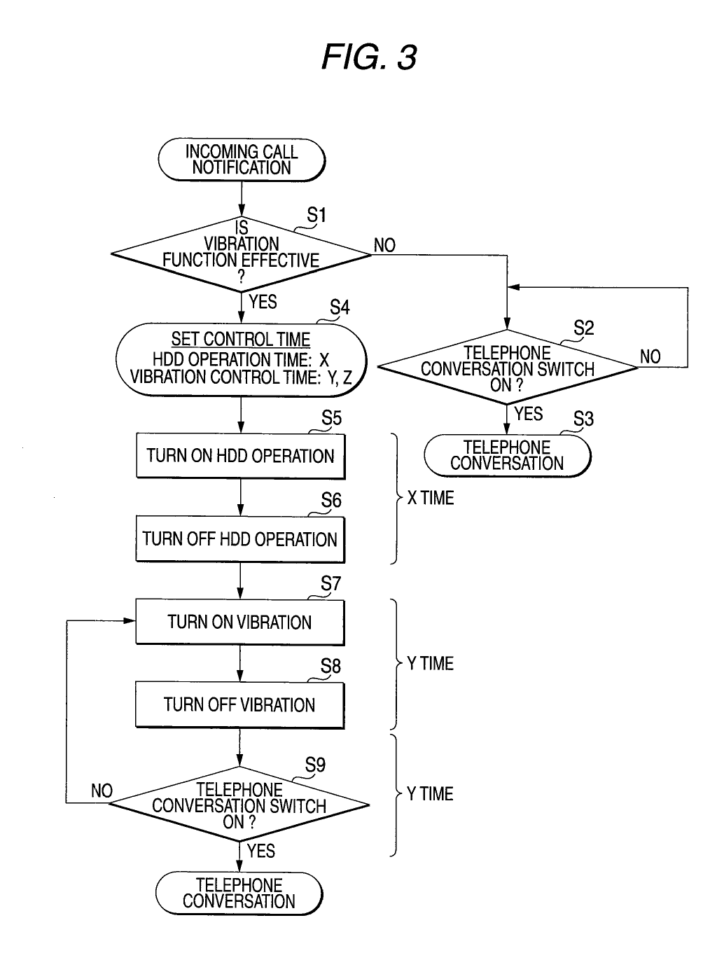

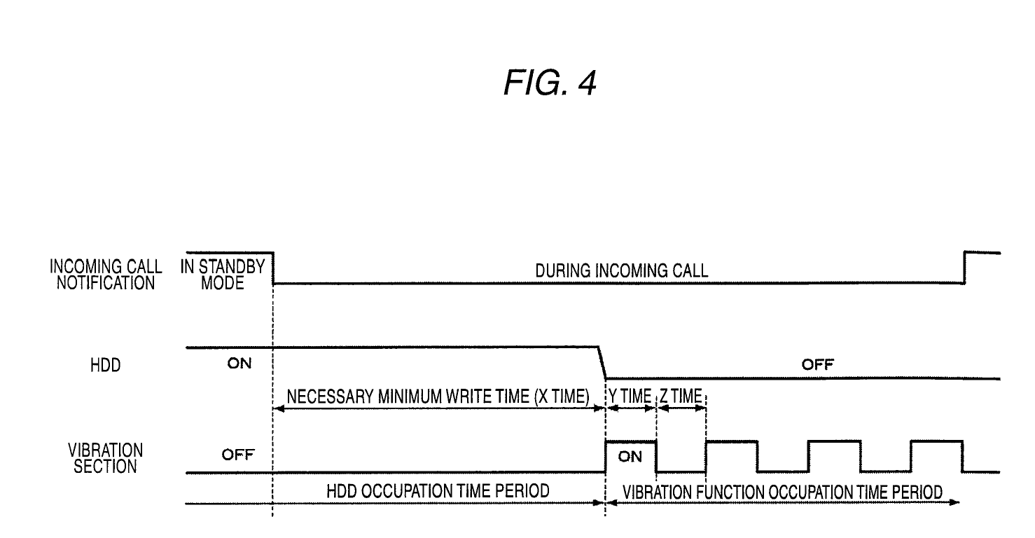

The operation of the described communication terminal will be discussed with FIGS. 3 and 4. FIG. 3 is a flowchart of the first embodiment for performing vibration control after completion of minimum necessary HDD write processing and FIG. 4 is a timing chart of the first embodiment for performing vibration control after completion of minimum necessary HDD write processing.

When incoming call notification is received in a standby mode, the control section 37 detects an incoming call request and determines whether or not the vibration function is effective (S1). If the vibration function is ineffective, whether or not a telephone conversation switch is ON is determined (S2) and routine processing is performed until the telephone conversation switch is turned ON and when the telephone conversation switch is turned ON, telephone conversation is started (S3).

On the other hand, if the vibration function is ineffective, the control section 37 sets HDD operation time X and vibration control times Y and Z (S4). Accordingly, as shown in FIG. 4, the hard disk drive 35 is turned ON (S5) and then is turned OFF (S6) for the minimum necessary write time X and subsequently, turning ON the vibrator section 31 (S7) for the Y time and turning OFF the vibrator section 31 (S8) for the Z time are repeated until the telephone conversation switch is turned ON. When it is determined that the telephone conversation switch is turned ON (S9), telephone conversation is started with the vibrator section 31 OFF.

That is, the time during the incoming call is distributed to the HDD occupation time period used as the read/write time period and the vibration function occupation time period used as the vibration time period.

According to the mobile telephone 100 of the first embodiment of the invention, the protection mode wherein when an incoming call request is detected during read/write from/to the hard disk drive 35, the read/write from/to the hard disk drive 35 is terminated before the vibrator section 31 is activated is provided in a selectable manner, so that when an incoming call request is detected during read/write, the control section 37 sets the read/write time period and the vibration time period and causes the hard disk drive 35 to complete necessary minimum write and then activates the vibrator section 31.

Accordingly, the communication terminal of the invention has the advantages that the vibration time period and the read/write time period do not overlap, that the hard disk drive 35 can be protected with high accuracy from vibration produced by the vibrator section 31, and that the processing wait time of the hard disk drive 35 and the processing wait time of notifying the user can be decreased.

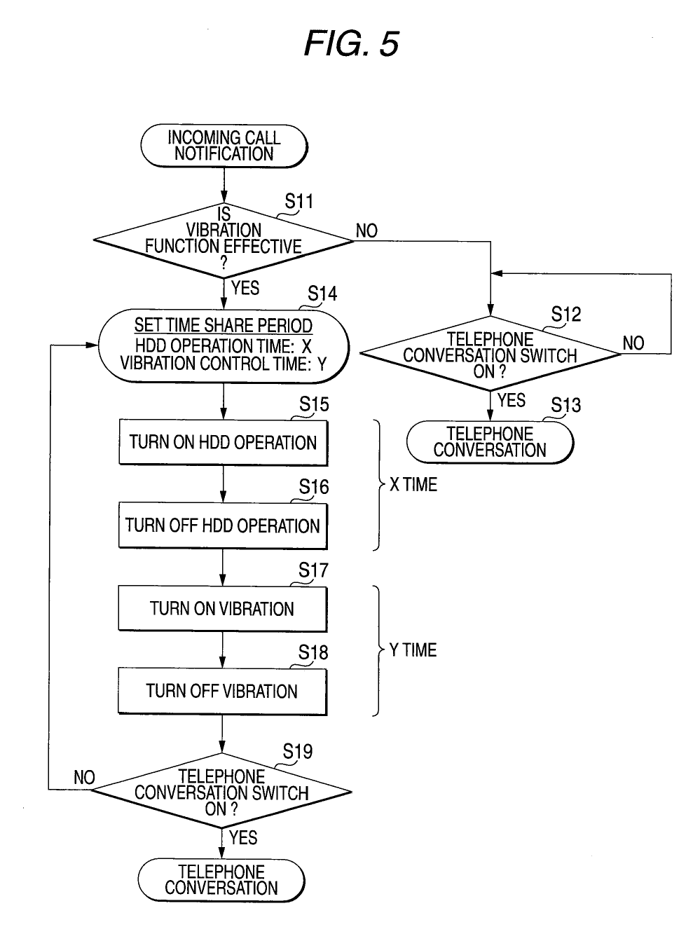

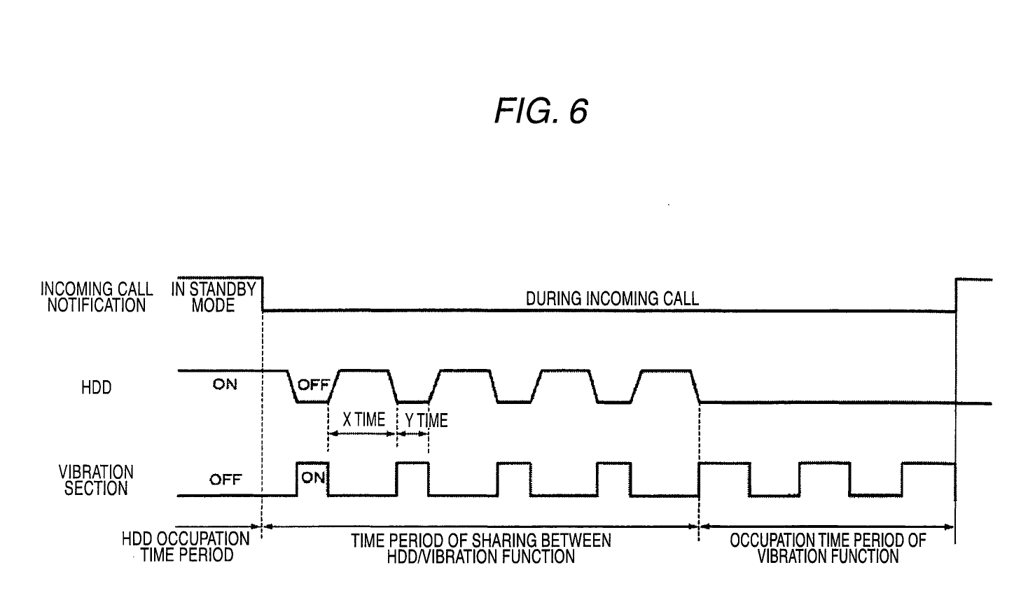

Next, a communication terminal of a second embodiment of the invention will be discussed with reference to FIGS. 5 and 6.

FIG. 5 is a flowchart of the second embodiment for time-sharing HDD processing and vibration control and FIG. 6 is a time chart of the second embodiment for time-sharing HDD processing and vibration control.

Members and parts equivalent to those shown in FIGS. 1 and 2 are denoted by the same reference numerals in the following embodiments and modified example and will not be discussed again.

A mobile telephone according to the second embodiment differs in setting of a control section 37.

That is, in the second embodiment, when incoming call notification is received in a standby mode, the control section 37 detects an incoming call request and determines whether or not the vibration function is effective (S11). If the vibration function is ineffective, whether or not a telephone conversation switch is ON is determined (S12) and routine processing is performed until the telephone conversation switch is turned ON and when the telephone conversation switch is turned ON, telephone conversation is started (S13).

On the other hand, if the vibration function is ineffective, the control section 37 sets HDD operation time X and vibration control time Y (S14). Accordingly, as shown in FIG. 6, a hard disk drive 35 is turned ON (S15) and then is turned OFF (S16) for the write time X and subsequently, turning ON a vibrator section 31 (S17) and turning OFF the vibrator section 31 (S18) for the Y time are repeated. When it is determined that a telephone conversation switch is turned ON (S19), telephone conversation is started with the vibrator section 31 OFF.

That is, the control section 37 repeats the vibration time period of the vibrator section 31 and the read/write time period of the hard disk drive 35 alternately.

As descried above, according to the communication terminal of the second embodiment of the invention, when an incoming call request is detected during read/write, the control section 37 sets a predetermined time share period and distributes the time share period to the vibration time period and the read/write time period alternately.

Therefore, vibration and read/write are executed alternately at a predetermined duty ratio and the still time of the vibrator section 31 is allocated to the read/write time and control not increasing both wait times is made possible.

Accordingly, it is made possible to activate the vibrator section 31 roughly at the same time as an incoming call request and while the hard disk drive 35 is protected, read/write is executed for decreasing the processing wait time of the hard disk drive 35, the vibrator section 31 is activated in the necessary shortest wait time, the processing wait time of notifying the user is decreased, and incoming call notification is not delayed.

If the read/write time period is shorter than the incoming call time, the time during the incoming call is distributed to the HDD/vibration function time share period and the vibration function occupation time period.

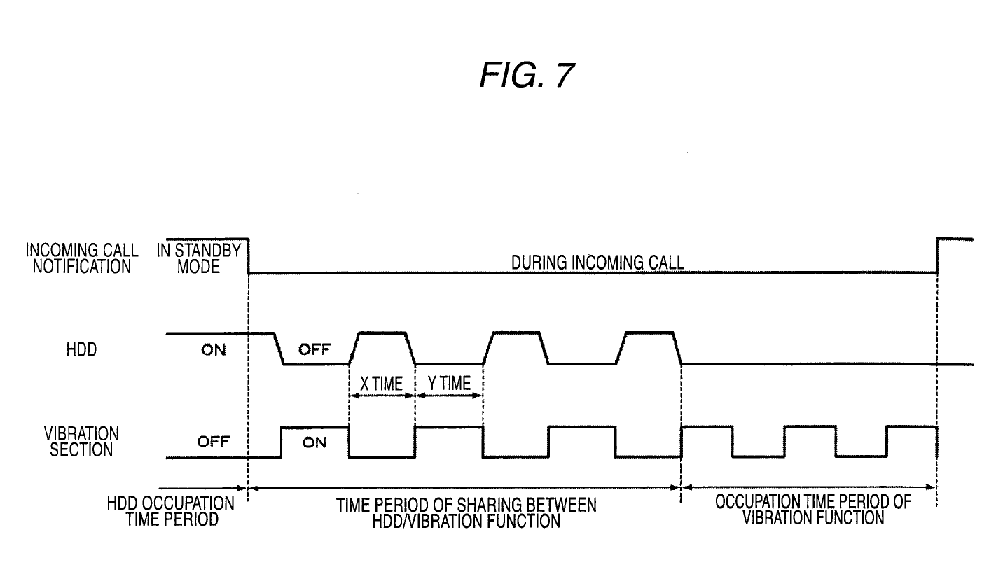

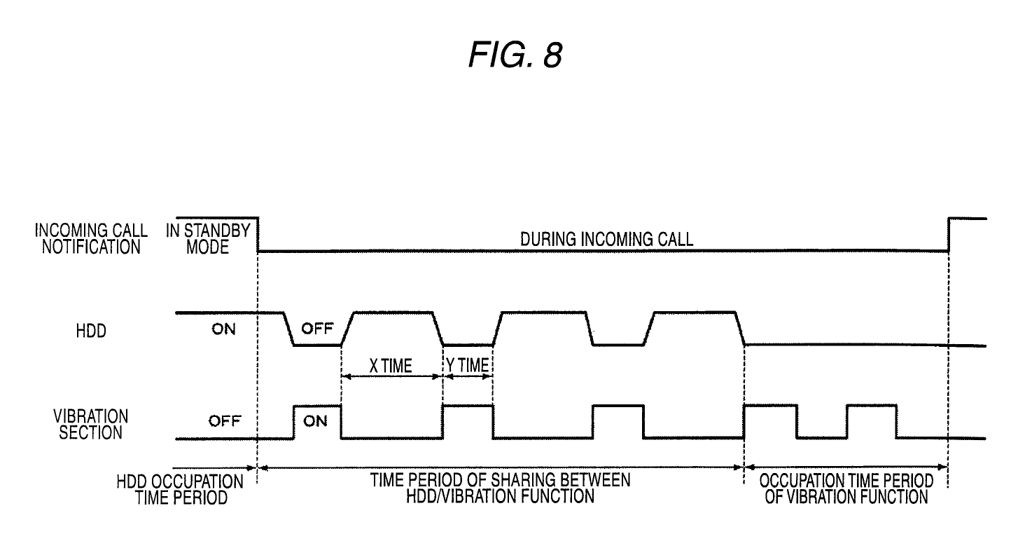

Next, a communication terminal of a third embodiment of the invention will be discussed with reference to FIGS. 7 and 8.

FIG. 7 is a timing chart of the third embodiment for time-sharing HDD processing and vibration control so that the time period can be changed and FIG. 8 is a timing chart of a modified example of the third embodiment for time-sharing HDD processing and vibration control so that the duty ratio can be changed.

A mobile telephone according to the third embodiment is configured so that a control section 37 can set any desired duty ratio between the vibration time period and the read/write time period.

That is, the HDD/vibration function time share period shown in FIG. 7 is the same time length as the HDD/vibration function time share period shown in FIG. 6, but the number of HDD processing times is small as three and vibration control time Y is set longer accordingly.

The HDD/vibration function time share period shown in FIG. 8 is set longer than the HDD/vibration function time share period shown in FIG. 7 and vibration control time Y is set short and HDD operation time X is set long accordingly.

As descried above, according to the communication terminal of the third embodiment of the invention, it is made possible to set the optimum time lengths of the vibration time period and the read/write time period of the duty ratio and it is made possible to set the optimum notification vibration pattern for the user or the optimum read/write operation pattern for target data.

Accordingly, the ratio between the vibration time period and the read/write time period can be adjusted in response to read/write processing of a hard disk drive 35, it is made possible to accomplish the effective and efficient vibration notification operation and read/write operation, and a request for critical read/write processing can be satisfied without suspending write of important data to be recorded continuously.

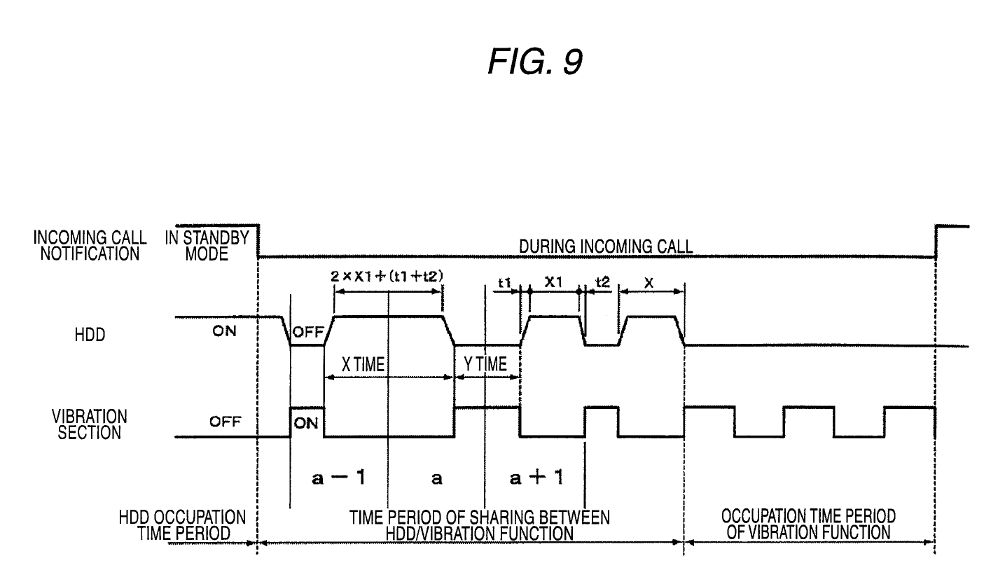

Next, a communication terminal of a fourth embodiment of the invention will be discussed with reference to FIG. 9.

FIG. 9 is a timing chart of the fourth embodiment for making it possible to change the time period in any desired pair of HDD processing and vibration control.

A mobile telephone according to the fourth embodiment has a configuration for making it possible to change the order of the vibration time period and the read/write time period in any desired pair of HDD processing and vibration control by a control section 37. That is, when repeating n pairs of the vibration time period and the read/write time period in a given order, the control section 37 inverts the order of vibration time period (vibration control time Y) and read/write time period (HDD operation time X) in an arbitrary pair a.

In the example in the figure, the order of the vibration control time Y and the HDD operation time X in the pair a is inverted as compared with the order in pair a−1 and the order in pair a+1.

The HDD operation time X contains magnetic disk rising rotation time period t1 and magnetic disk rotation stop time period t2 before and after substantial write time X1. That is, X=X1+t1+t2. If two read/write time periods (HDD operation time X) are continued by inversion as in the embodiment, the rising rotation time period t1 and the magnetic disk rotation stop time period t2 are excluded in the continuation part and the substantial write time increases accordingly.

That is, when inversion is not executed, the total HDD operation time in the three pairs is 3×X1; while, it is made possible to increase the total HDD operation time in the three pairs as 3×X1+(t1+t2) by executing inversion.

As descried above, according to the communication terminal of the fourth embodiment of the invention, one of the vibration time period and the read/write time period continues across the pairs a−1 and a and the other continues across the pairs a and a+1.

It is made possible to use the time not substantially consumed for the vibration or read/write operation (t1+t2) as the read/write time period because of the continuation and accordingly the read/write time period is shortened and effective notification is made possible.

The case where the communication terminal is the mobile telephone 100 has been described by way of example, but the invention can also be embodied in a similar manner for any other communication terminal including a hard disk drive and a vibration section.

This application is based on Japanese Patent Application (No. 2005-113338) filed on Apr. 11, 2005, which is incorporated herein by reference.

### INDUSTRIAL APPLICABILITY

As described above, the communication terminal according to the invention has the advantages that the vibration time period and the read/write time period do not overlap, that the hard disk drive can be protected with high accuracy from vibration produced by the vibrator section, and that the processing wait time of the hard disk drive and the processing wait time of notifying the user can be decreased, and can be applied preferably to the use of a communication terminal including a vibration section and a hard disk drive in the same cabinet and the like.

1. A communication terminal, comprising:
a communication section which transmits and receives various pieces of data to and from an external apparatus;
a hard disk drive;
a control section which controls the communication section and the hard disk drive; and
a vibration section which notifies of an incoming call based on an incoming call request obtained by the communication section,
wherein when the control section detects the incoming call request during reading from or writing to the hard disk drive, the control section operates the vibration time period of the vibration section and the read/write time period of the hard disk drive alternately.

2. The communication terminal as set forth in claim 1, wherein the control section can set a desired duty ratio between the vibration time period and the read/write time period.

3. The communication terminal as set forth in claim 1, wherein the control section repeats n pairs of the vibration time period and the read/write time period in a given order, and inverts back and forward of the vibration time period and the read/write time period in an arbitrary pair.

4. The communication terminal as set forth in claim 1, wherein before the vibration section activates, a head of the hard disk drive is retreated from a record face and is maintained at a retreat position until the vibration section stops.

5. (canceled)
